(19) United States
(12) Patent Application Publication
(10) Pub. No.: US 2024/0108120 A1
(43) Pub. Date: Apr. 4, 2024

(54) Container

(71) Applicant: Home Equity Renovations and Design Inc., Bensalem, PA (US)

(72) Inventor: Douglas Raymond Knoblauch, Newtown, PA (US)

(73) Assignee: Home Equity Renovations and Design Inc., Bensalem, PA (US)

(21) Appl. No.: 18/531,351

(22) Filed: Dec. 6, 2023

Related U.S. Application Data
(63) Continuation-in-part of application No. 18/527,121, filed on Dec. 1, 2023.
Application No. 18/527,121 is a continuation of application No. 17/855,946, filed on Jul. 1, 2022.
Application No. 17/855,946 is a continuation of application No. 17/000,656, filed on Aug. 24, 2020, now Pat. No. 11,395,537.
(60) Provisional application No. 63/100,025, filed on Feb. 25, 2020.
(60) Provisional application No. 62/922,726, filed on Aug. 26, 2019.

(51) Int. Cl. A45F 5/02; B25H 3/02

(52) U.S. Cl. CPC A45F 5/021; B25H 3/022; A45F 2200/0575

(57) ABSTRACT

A container including a clip attached at a clip first end to the container body and having a downwardly extending clip arm terminating in a clip second end for securing the container to a substrate disposed between the downwardly extending clip arm and the container body. In particular embodiments, the clip arm can include a clip aperture configured as the first of a pair of mateable fastener removably mateable to a second of the pair of mateable fasteners to removably affix the container to another surface or device.

This United States patent application is a continuation-in-part of U.S. patent application Ser. No. 18/527,121, filed Dec. 1, 2023, which is a continuation of U.S. patent application Ser. No. 17/855,946, filed Jul. 1, 2022, which is a continuation of U.S. patent application Ser. No. 17/000,656, filed Aug. 24, 2020, now U.S. Pat. No. 11,395,537, issued Jul. 26, 2022, which claims the benefit of U.S. Provisional Patent Application No. 63/100,025, filed Feb. 25, 2020, and U.S. Provisional Patent Application No. 62/922,726, filed Aug. 26, 2019, each hereby incorporated by reference herein.

### I. FIELD OF THE INVENTION

A container including a clip attached at a clip first end to the container body and having a downwardly extending clip arm terminating in a clip second end for securing the container to a substrate disposed between the downwardly extending clip arm and the container body. In particular embodiments, the clip arm can include a clip aperture configured as the first of a pair of mateable fastener removably mateable to a second of the pair of mateable fasteners to removably affix the container to another surface or device.

### II. BACKGROUND OF THE INVENTION

There are a wide variety of devices that include containers configured to hold materials. In many devices the containers are not removable, thus each container must be emptied to receive additional materials of a different type. There would be substantial advantage in a container having container body having a fastener removably mateable to a substrate material and/or including a first of a pair of mateable fasteners removably mateable to a second of said pair of mateable fasteners to removably affix said container to a substrate material or a device.

### III. SUMMARY OF THE INVENTION

Accordingly, a broad object of particular embodiments of the invention can be provision of a container including a clip having a clip arm attached by clip first end to a container body proximate the container rim and downwardly extending to terminate in a clip second end, wherein a substrate material can be received between the clip arm and the container body to removably secure the container to the substrate material and in particular embodiments the clip includes a clip aperture circumscribed by clip aperture edges which define a first of a pair of mateable fasteners removably mateable to a second of said pair of mateable fasteners to removably affix said container to a substrate material or a device.

Another broad object of particular embodiments of the invention can be a method of making a container including coupling a clip to a container, wherein the clip incudes a clip arm attached by clip first end proximate the container rim and downwardly extending to terminate in a clip second end, whereby a substrate material can be received between the clip arm and the container body to removably secure the container to the substrate material and in particular embodiments circumscribing a clip aperture by clip aperture edges which define a first of a pair of mateable fasteners removably mateable to a second of said pair of mateable fasteners to removably affix said container to a substrate material or a device.

Another broad object of particular embodiments of the invention can be a method of using a container including removably mateably fastening a first of a pair of mateable fasteners of a container to a second of said pair of mateable fasteners of a substrate material or a device to removably affix said container to a substrate material or a device, wherein the first of the mateable fasteners can be configured as a clip coupled the container, wherein the clip incudes a clip arm attached by clip first end proximate the container rim and downwardly extending to terminate in a clip second end, whereby a substrate material can be received between the clip arm and the container body to removably secure the container to the substrate material, and in particular embodiments, the clip can include a clip aperture circumscribed by clip aperture edges which receives the second of said pair of mateable fasteners to removably affix said container to a substrate material or a device.

Naturally, further objects of the invention are disclosed throughout other areas of the specification, drawings, photographs, and claims.

### IV. BRIEF DESCRIPTION OF THE DRAWINGS

FIG. 1 is a rear perspective view of a particular embodiment of a container.

FIG. 2 is a rear elevation view of the particular embodiment of a container.

FIG. 3 is a front elevation view of the particular embodiment of a container.

FIG. 4 is a first side elevation view of the particular embodiment a container.

FIG. 5 is a second side elevation view of the particular embodiment of a container.

FIG. 6 is a top plan view of the particular embodiment of a container.

FIG. 7 is a bottom plan view of the particular embodiment of a container.

FIG. 8 is a front perspective view of a particular embodiment of a fastener removably mateable with particular embodiments of the container.

FIG. 9 is a rear perspective view of a particular embodiment of a fastener removably mateable with particular embodiments of the container.

FIG. 10 is an exploded view of a particular embodiment of the fastener securable to a substrate material.

FIG. 11 is a front elevation view of a particular embodiment of a fastener removably mateable with particular embodiments of the container.

FIG. 12 is a rear elevation view of a particular embodiment of a fastener removably mateable with particular embodiments of the container.

FIG. 13 is a first side elevation view of a particular embodiment of a fastener removably mateable with particular embodiments of the container.

FIG. 14 is a second side elevation view of a particular embodiment of a fastener removably mateable with particular embodiments of the container.

FIG. 15 is a top plan view of a particular embodiment of a fastener removably mateable with particular embodiments of the container.

FIG. 16 is bottom plan view of a particular embodiment of a fastener removably mateable with particular embodiments of the container.

FIG. 17 illustrates a particular method of using a particular embodiment of the fastener configured to hang from a perforated material to removably mated with particular embodiments of the container.

FIG. 18 is a perspective view of a particular embodiment of the fastener configured to hang from a perforated material.

FIG. 19 illustrates a particular method of using a particular embodiment of the fastener to removably mate the container to a belt suspended tool holder.

FIG. 20 illustrates a particular method of using a particular embodiment of the fastener to removably mate the container to a receptacle.

### V. DETAILED DESCRIPTION OF THE INVENTION

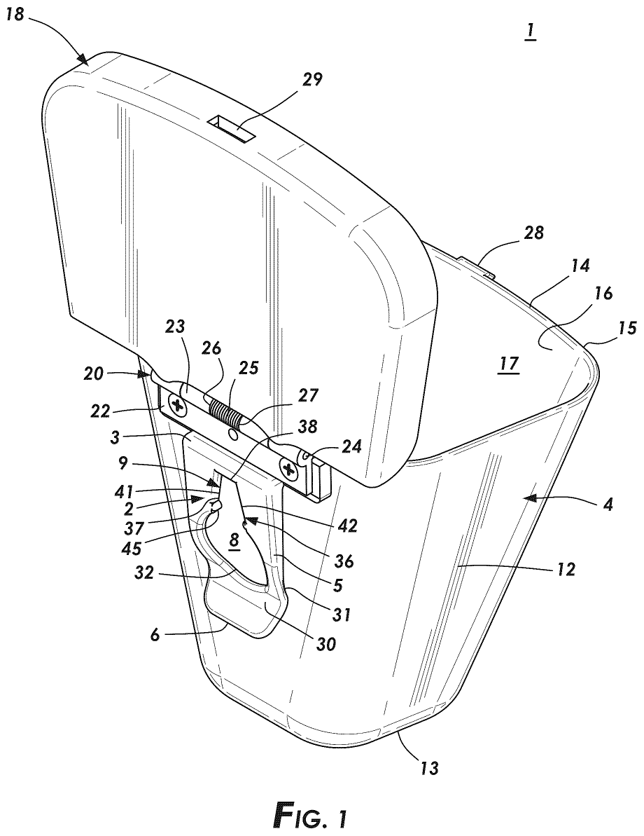

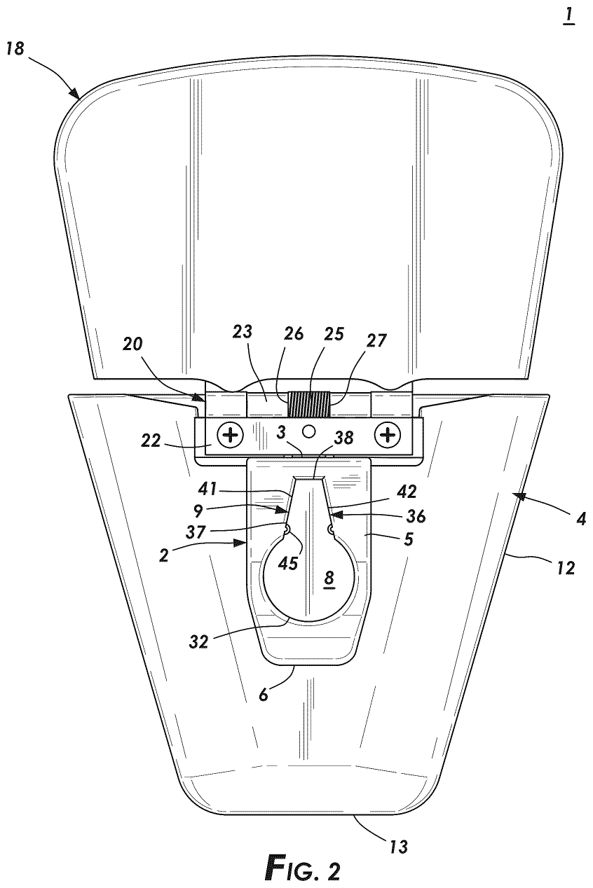

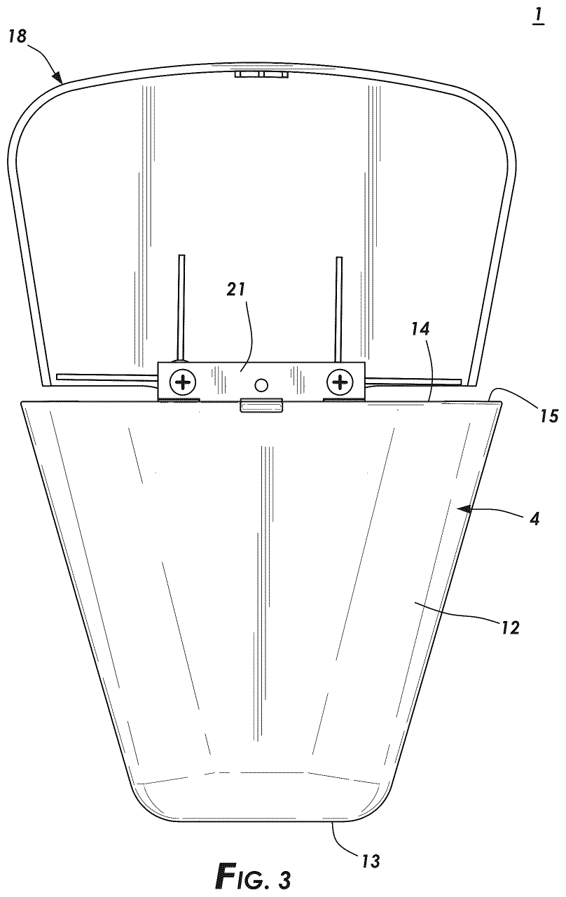

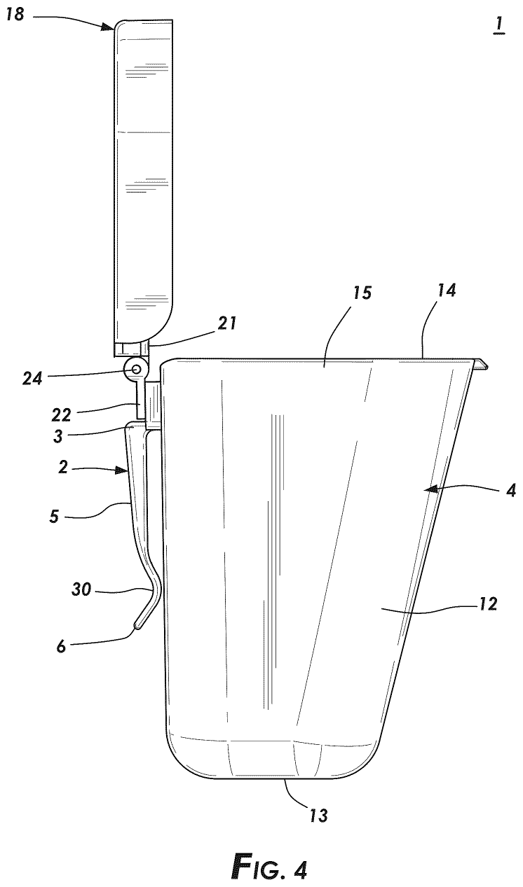

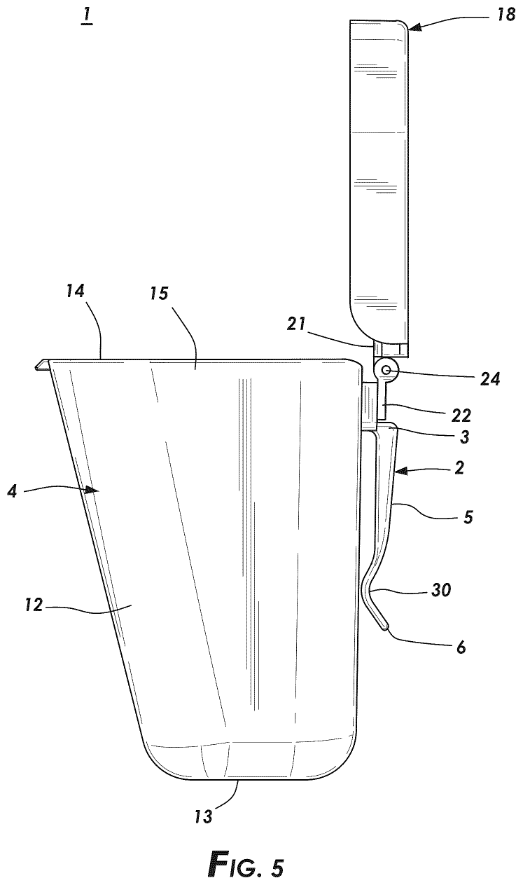

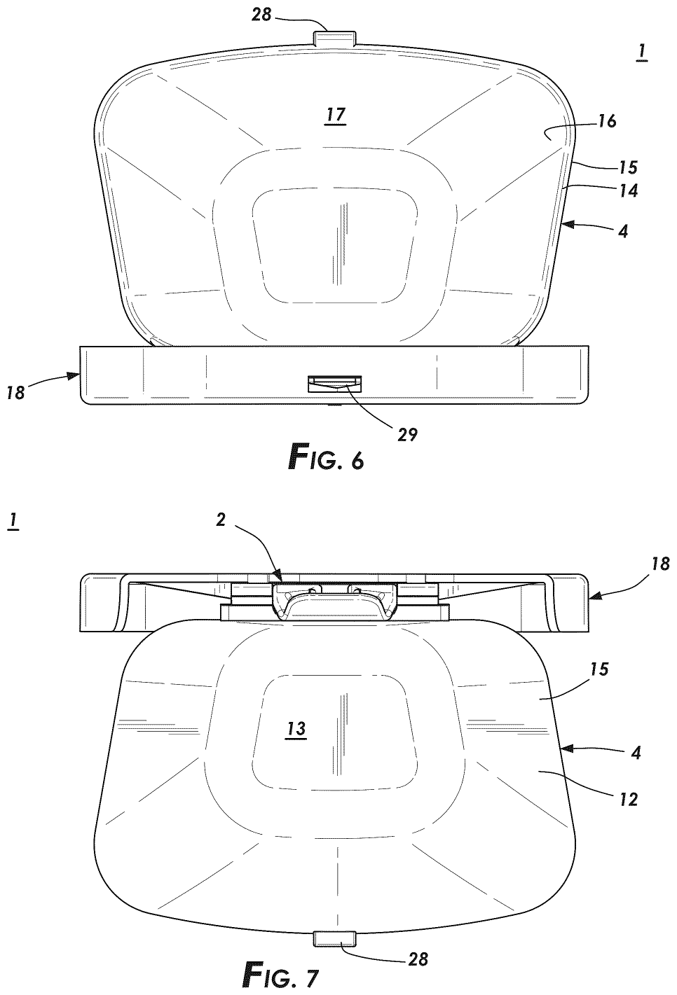

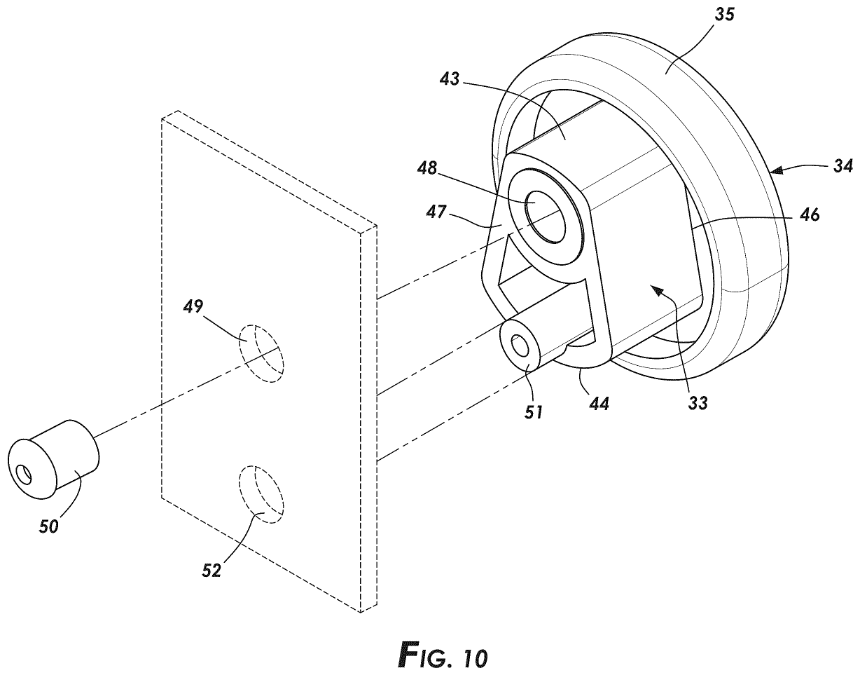

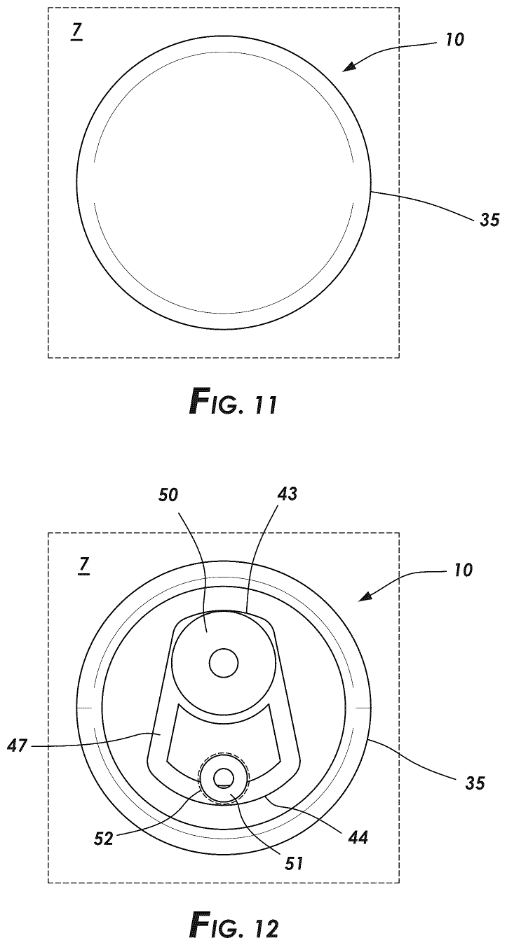

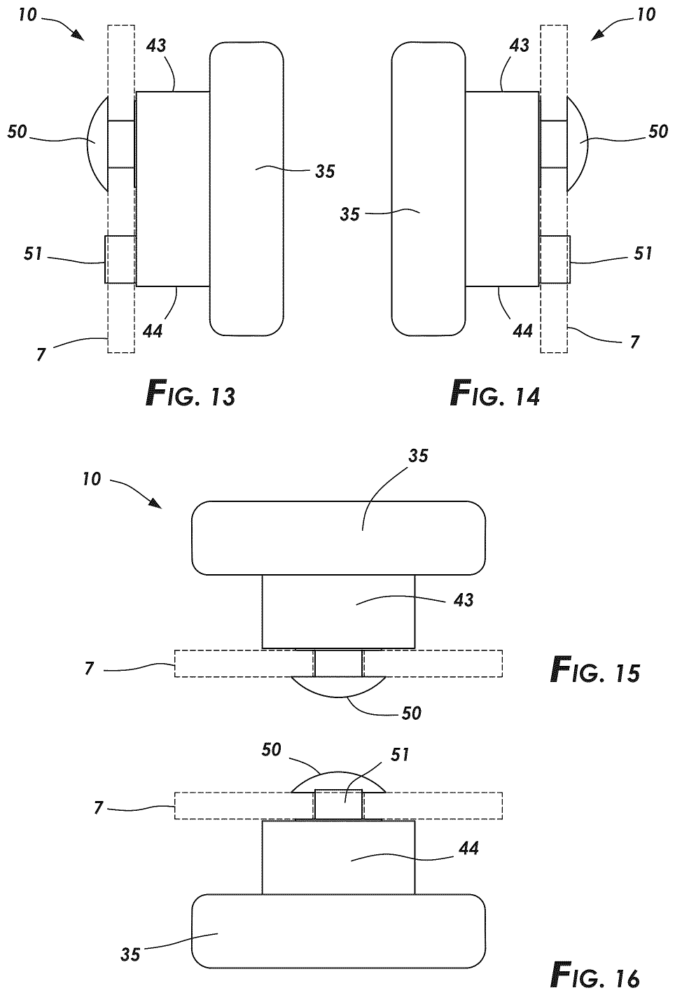

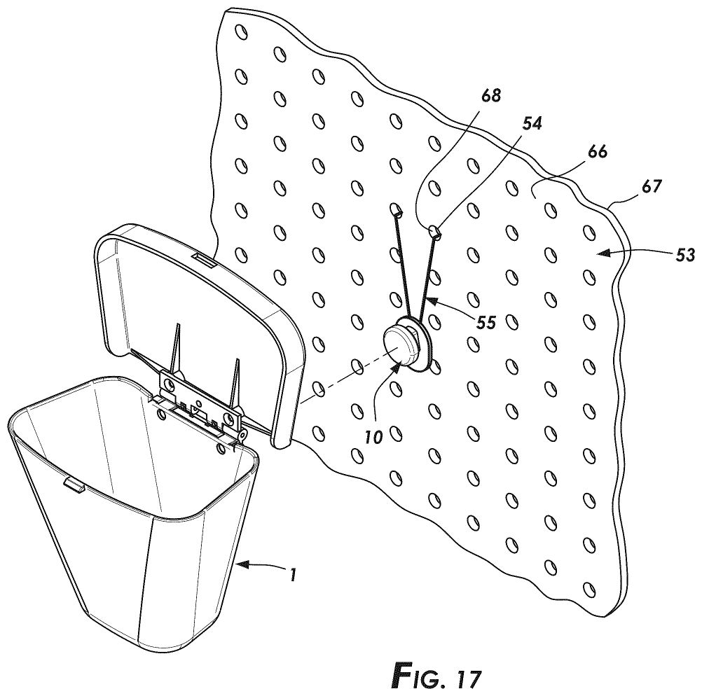

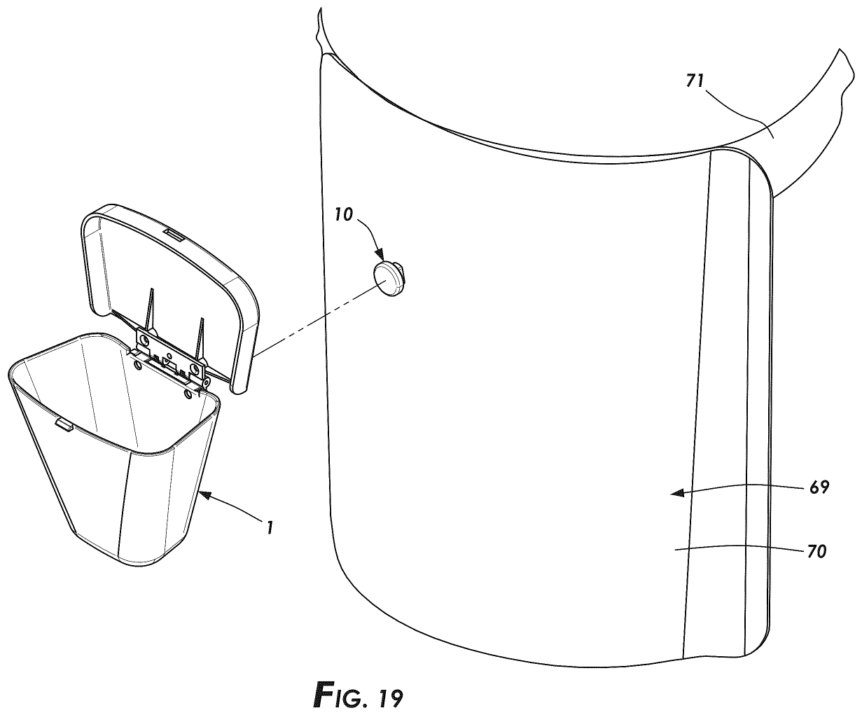

Generally, referring to FIGS. 1 through 20, which depict particular embodiments of a container (1) and methods of making and using a container (1) including a clip (2) attached at a clip first end (3) to a container body (4) and having a downwardly extending clip arm (5) terminating in a clip second end (6) for securing embodiments of the container (1) to a substrate material (7) disposed between the downwardly extending clip arm (5) and the container body (4). In particular embodiments, the clip arm (5) can include a clip aperture (8) configured as a first of a pair of mateable fasteners (9) removably mateable to a second of the pair of mateable fasteners (10) to removably affix the container (1) to substrate material (7) or other device (11).

Now, with primary reference to FIGS. 1 through 7, in particular embodiments, the container (1) can include a container body (4) having container sidewalls (12) upwardly extending from a container bottom (13) to a container rim (14). The container body (4) defines the configuration of a container external surface (15) and a container internal surface (16), wherein the container internal surface (16) defines a container interior space (17).

The container internal surface (16) can be configured to define a container interior space (17) for a wide variety of purposes, including structural configurations to hold tools, such as: tape measures, bubble levels, screw drivers, hammers, pressure gauges, pliers, wrenches, tube guns, or the like; or to hold materials, such as: liquids, solids, semi-solids, pastes or gels, such as: adhesives, lubricants, solvents, fuels, primers, paints, or the like, or to hold materials used join materials, such as: nails, screws, set screws, bolts and nuts, pins and rivets, crimps, snap-fits, shrink fits, clamps, clasps, clips, grommets, latches, pegs, pins, bands, ties, tags, twist ties, zip ties, zippers, staples, or the like, and combinations thereof; however, these illustrative examples do not preclude utilization of the container (1) to hold any manner of objects or materials.

The container body (4) can be produced as one-piece or can be fabricated from component parts. While the container body (4) can comprise a substantially inflexible rigid structure, in particular embodiments, the container body (4) can be made from a pliable material, such as: woven material (whether of natural or synthetic fibers), perforate sheet, leather, or combinations of rigid materials or combinations of pliable materials or combinations of rigid and pliable materials. In particular embodiments, the container body (4) can be configured to fit within a pocket of another device (11), such as a pocket of a conventional tool belt. This allows a plurality of containers (1) holding different materials, to be readily exchanged, without having to empty and refill the pockets of the conventional tool belt. In the illustrative embodiment of FIGS. 1 through 7, the container body (4) comprises a substantially inflexible material which tapers from the container rim (14) approaching the container bottom (13). The container bottom (13) being configured to be readily received within a sleeve, pocket or receptacle of another device (11) and upon forcible urging the taper in the container body (4) can create an interference fit with the sleeve, pocket or receptacle of another device (11) to secure the container (1) in the sleeve, pocket or receptacle of another device (11).

Again, with primary reference to FIGS. 1 through 7, in particular embodiments, the container (1) can further include a top cover (18) having a top attachment portion (19) interconnecting the top cover (18) to the container body (4). The illustrative examples of FIGS. 1 through 7, include a hinge (20) interposed between the top cover (18) and the container body (4) to allow the top cover (18) to rotate between a closed condition (CC) and an open condition (OC). The hinge (20) can take the form of a pair of leaves (21, 22), a knuckle (23) and a pin (24). The pin (24) can be inserted through the knuckle (23) when the leaves (21, 22) are joined. The first of the pair leaves (21) joined to the container body (4) and a second of the pair of leaves (22) joined to the top cover (18). However, the hinge (20) can be structured in any configuration that allows the top cover (18) to move between the open condition (OC) and the closed condition (CC). For example, the container body (4) and the top cover (18) may be joined by a living hinge or be joined to the opposite ends of a flexible tether.

Again, with primary reference to FIGS. 1 through 7, in particular embodiments, a torsion spring (25) biasedly disposed about the hinge pin (24) includes first and second torsion spring ends (26, 27) biasing against the container body (4) and the cover top (18) respectively providing torsion force (F) to urge the top cover (18) toward the open condition (OC). The top cover (18) can be held in the closed condition (CC) by a projection (28) disposed on the container body (4). The projection (28) can be configured to be insertingly received in a cover aperture (29) in the top cover (18). In particular embodiments, the container body (4) can be inwardly flexed to remove the projection (28) from the cover aperture (29) to allow the top cover (18) to move toward the open condition (OC). There is a substantial advantage in the top cover (18) being biased toward the open condition (OC) during normal use in that the top cover (18) can be opened by operation of one hand, moves to the open condition (OC) without user interaction, and remains in the open condition (OC) out of way of the user reaching for materials within the container (1). The container (1) can be readily closed by one hand operation to push the top cover (18) to the closed condition (CC) to engage the projection (28) with the top cover aperture (29).

Again, with primary reference to FIGS. 1 through 7, in particular embodiments, the container (1) can include a clip (2) attached at a clip first end (3) to the container body (4) and having a downwardly extending clip arm (5) terminating in a clip second end (6). The clip (2) can secure the container (1) to a substrate material (7) by inserting the substrate material (7) between the downwardly extending clip arm (5) and the container body (4). In particular embodiments, the downwardly extending clip arm (5) can comprise a resilient material which resiliently flexes to assert additional compression force on the substrate material (7) disposed between the container body (4) and the clip arm (5). The clip (2) can further include an inward curvature (30) of the clip arm (5) proximate the clip second end (6) to enhance the compression force exerted on the substrate material (7). The clip (2) can further include an outward curvature (31) proximate the clip second end (6) to dispose the clip second end (6) a distance from the container body (4) to allow the clip second end (6) to slidably engage the substrate material (7) and guide it to a position between the container body (4) and the downwardly extending clip arm (5). The term “substrate material” means any material or layer which can be disposed between the container body (4) and the clip arm (5) and without limitation to the breadth of the foregoing, the substrate material (7) can comprise a belt, a strap, a band, a waist belt, a pocket, a ribbon, a cord, or the like.

Now, with primary reference to FIGS. 1 through 2 and 8 through 16, in particular embodiments of the clip arm (5) can include therethrough a clip aperture (8). The clip aperture (8) can be configured as the first of a pair of mateable fasteners (9). The clip aperture (8) can be defined by a clip aperture edge (32) circumscribing the clip aperture (8). In particular embodiments, the clip aperture edge (32) can define a clip aperture (8) configured as a first of a pair of mateable fasteners (9) which can receive a second of a pair of mateable fasteners (10). The second of a pair of mateable fasteners (10) can comprise a post (33) terminating in a post end (34) which outwardly radially extends from the post (33). The post end (34) can pass through the clip aperture (8). The clip aperture edge (32) can be positioned to contact the post (33) to dispose a portion of the post end (34) between the container body (4) and the clip arm (5) to removable secure the second of a pair of mateable fasteners (10) to the clip arm (5). The clip arm (5) can be moved upward to align the post end (34) with the clip aperture (8) and pass through the clip aperture (8) to disengage the clip arm (5) from the second of the pair of mateable fasteners (10). In the illustrative example of FIGS. 8 through 16 the post end (34) has a circular periphery (35); however, this is not meant to preclude embodiments of the post end (34) having other than a circular or elliptical periphery and the post end (34) can be of any configuration that allows the post end (34) to pass through the clip aperture (8) and at least a portion to reside between the container body (4) and the clip arm (5) to resist disengagement of the post end (34) from the clip arm (5).

Again, with primary reference to FIGS. 1 through 2 and 8 through 16, in particular embodiments, the clip aperture edge (32) can be further configured to afford a post receiving channel (36). The post receiving channel (36) having a channel first end (37) open to the clip aperture (8). The post receiving channel (36) can extend toward the clip first end (3) to terminate in a closed channel second end (38). The post end (34) can pass through the clip aperture (8) to align the post (33) with the post receiving channel (36). The post (33) can be sliding received by the post receiving channel (36) to dispose the post end (34) between the container body (4) and the clip arm (5) to removably secure the second of the pair of mateable fasteners (10) to the clip arm (5). The clip arm (5) can be moved upward to slidably disengage the post (33) from the post receiving channel (36) and align the post end (34) with the clip aperture (8). The post end (34) can then pass through the clip aperture (8) to disengage the second of the pair of mateable fasteners (10) from the clip arm (5).

Again, with primary reference to FIGS. 1 through 2 and 8 through 16, in particular embodiments, the post (33) can have an orthogonal cross section which can be slidably received in the post receiving channel (36) and arrests rotation of the clip arm (5) about the post (33). As an illustrative example, the post (33) can include a pair of substantially parallel opposed post sides (39, 40) and the post receiving channel (36) can correspondingly include a pair of substantially parallel opposed channel edges (41, 42). Thus, the post (33) slidably inserted into the post receiving channel (36) can be substantially arrested from rotation within the post receiving channel (36). In particular embodiments, the post receiving channel (36) can inwardly taper approaching the channel second end (38). Thereby, the channel first end (37) can have an opening of greater width than the closed channel second end (38). The opposed post sides (39, 40) can correspondingly taper between post taper narrow end (43) and a post taper wide end (44). The post taper narrow end (43) can be readily slidingly received in the channel first end opening (37) and moved to create an interference fit between the tapered opposed post sides (39, 40) and the tapered post receiving channel edges (41, 42). The taper in the post receiving channel (36) and the post (33) facilitates receiving the post (33) into the post receiving channel (36) and assists in arresting rotation of the clip arm (5) around the post (33).

Again, with primary reference to FIGS. 1 through 2 and 8 through 16, in particular embodiments, one or both of the opposed channel edges (41, 42) proximate the channel first end (37) can include a detent (45) over which the post (33) can be forcibly urged and can resist release of the post (33) received into the post receiving channel (36).

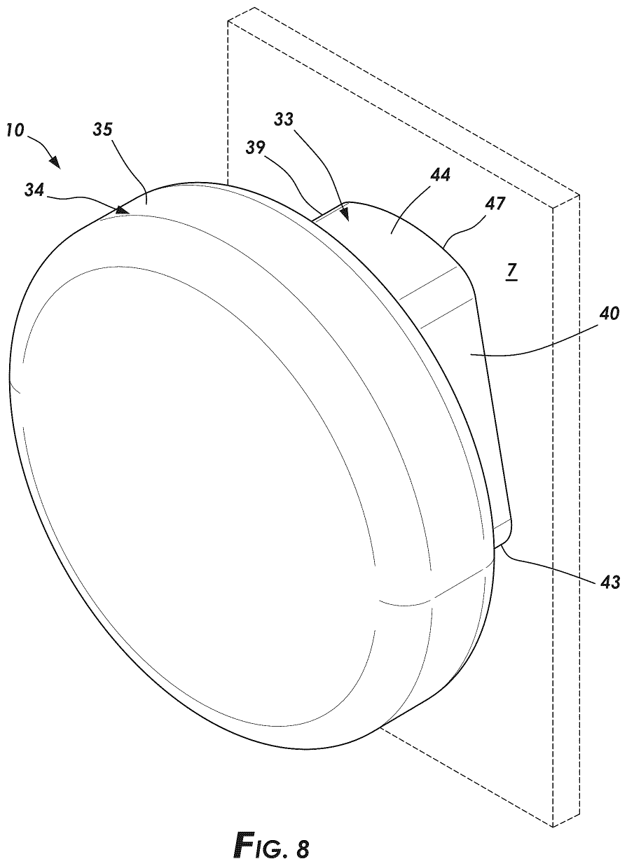

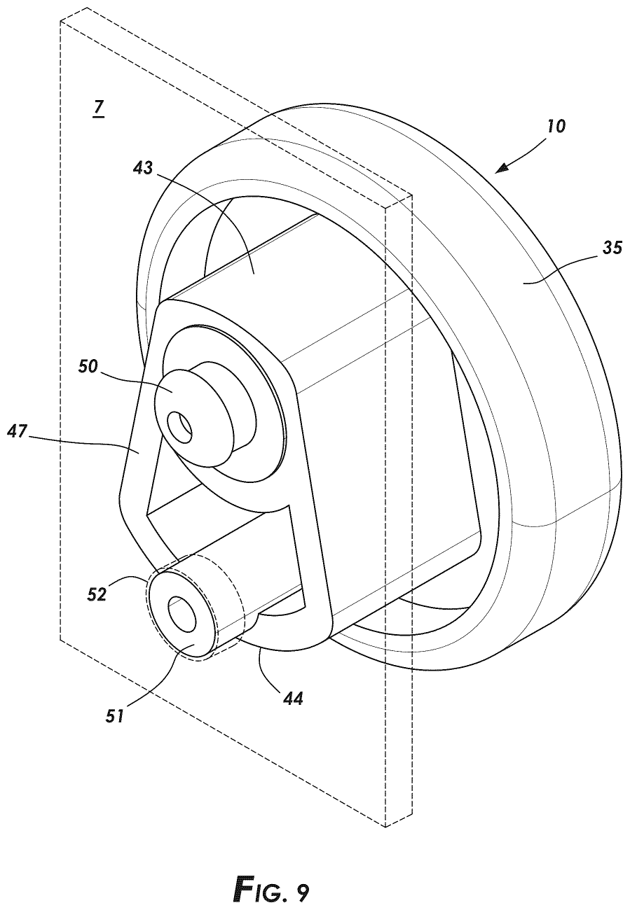

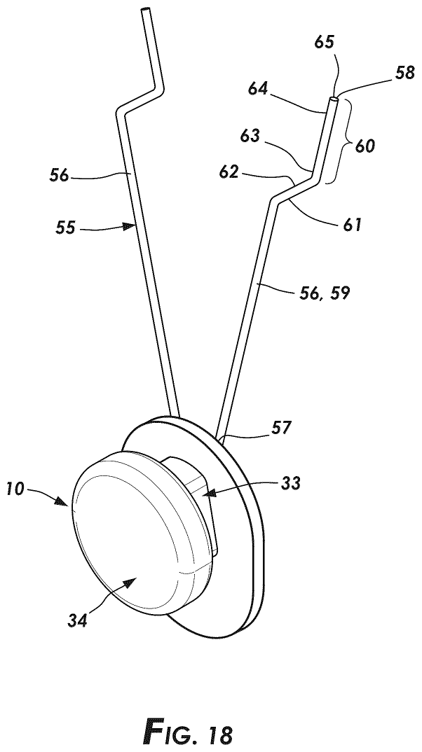

Now, with primary reference to FIGS. 8 through 16, the second of the pair of mateable fasteners (10) can include the post end (34) coupled to a post first end (46) of the post (33). In particular embodiments, the post end (34) and the post (33) be integrated as one piece. A post second end (47) of the post (33) can be coupled to a substrate material (7). In particular embodiments, the post end (34), the post (33) and the substrate material (7) can be integrated as one piece. The term “substrate material” means any material and any material configuration to which the post second end (47) can be affixed to, attached to, or coupled to in fixed spatial relation or in removable fixed spatial relation. In the illustrative examples of FIGS. 9 and 10, the second of the pair of mateable fasteners (10) comprises a post end (34) and a post (33) having a post second end (47) having rivet hole (48) alignable with a first substrate material perforation (49) through which a rivet (50) passes into the rivet hole (48) and the rivet (50) can expand to secure the post (33) to the substrate material (7). In particular embodiments, the post second end (47) can further includes a protuberance (51) alignable and disposed in a second substrate material perforation (52). Thereby, when the rivet (50) secures the post second end (47) to the substrate material (7), the protuberance (51) arrests rotation of the post around the rivet (50). This illustrative example is not intended to preclude other ways of attaching the second of the pair of mateable fasteners (10) to a substrate material (7) (shown in the example of FIGS. 8 through 16 in broken line), including as examples: threaded fasteners, adhesives, interference fit, spin welding, clips, hangers, and forming the second of the pair of mateable fasteners (10) and the substrate material (7) as an integrated one-piece structure. The term “substrate material” broadly encompasses the surface of any material to which the second of the pair of mateable fasteners (10) can be secured in fixed or removeable fixed spatial relation and in particular includes the examples of FIGS. 17 through 20.

Now, with primary reference to FIG. 17, in particular embodiments the second of the pair of mateable fasteners (10) can be configured to attach or removably attach to a perforated material (53) having one or more small holes (54). The illustrative example of FIG. 17 depicts a perforated material (53) having a regular pattern of small holes (54); however, the perforated material (53) may include only one or a plurality of perforations or holes (54) which may be regularly or irregularly spaced apart in the perforated material (53). The second of the pair of mateable fasteners (10) can include a hanger (55) coupled to the second of the pair of mateable fasteners (10). The hanger (55) includes one or more hanger prongs (56) having a hanger prong first end (57) coupled to the second of the pair of mateable fasteners (10) and a hanger prong second end (58) configured to insert into one or more of the holes (54) in the perforated material (53). In the particular example of FIG. 17, the hanger (55) includes a bifurcate hanger prong (59) extending from the second of the pair of mateable fasteners (10) with each of the hanger prongs (56) including a prong hook (60) including a first bend (61) substantially perpendicular to longitudinal axis of the corresponding hanger prong (56) to afford an outward extent (62) of the hanger prong (56) of greater thickness than the perforated material (53) and a second bend (63) substantially perpendicular to the outward extent (62) of the hanger prong (56) to afford a longitudinal extent (64) of the hanger prong (56) which terminates in a prong free end (65). The prong free end(s) (65) correspondingly insert through a hole (54) in the perforated material (53) from a perforated material front surface (66) to a perforated material back surface (67) to dispose the outward extent (62) of the hanger prong (56) resting on the perforated material hole periphery (68) with the longitudinal extent (64) contacting the perforated material back surface (67). Now, when the hanger is released it hangs from the perforated material (53) able to receive the first mateable fastener (9) included in the container clip (2).

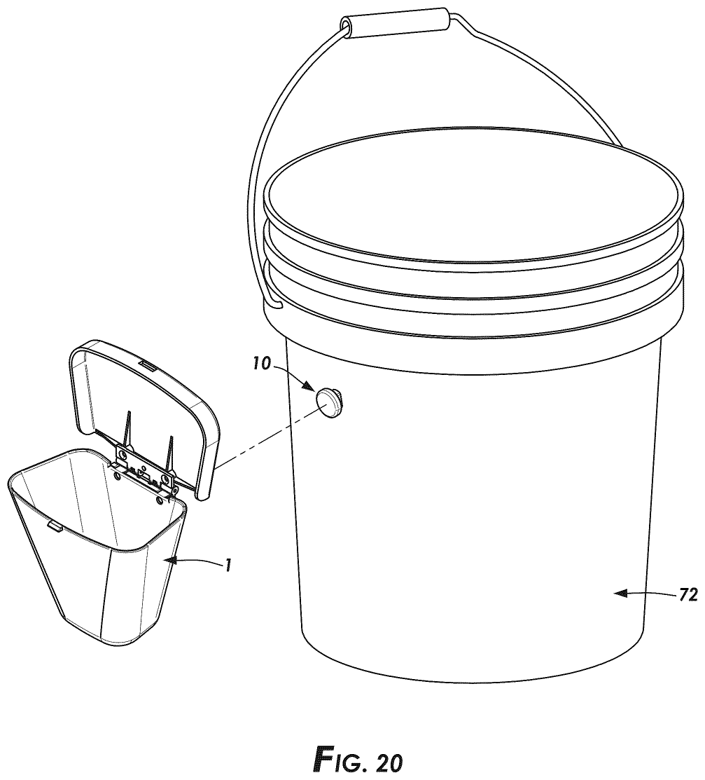

Now, with primary reference to FIG. 19, in particular embodiments one or more of the second of the pair of fasteners (10) can be affixed to a belt mountable tool belt or holder (69). In the particular example of FIG. 19 the belt mountable holder (69) includes an arcuate member (70) suspendable from a belt (71) which can be disposed about the waist of a wearer to releasably couple one or more containers (1); however, this is not intended to preclude embodiments in which the second of the pair of fasteners (10) can be affixed to a conventional tool holders or tool belts.

Now, with primary reference to FIG. 20, in particular embodiments one or more of the second of the pair of fasteners (10) can be affixed to a receptacle (72). In the example, of FIG. 20, the receptacle (72) comprises a conventional five gallon bucket; however, this is not intended to preclude embodiments in which the second of the pair of fasteners (10) can be affixed to any type of receptacle (72) including as examples: tool chests, tool boxes, tackle boxes, storage cabinets, filing cabinets, work benches, and the like.

In particular embodiments, the containers (1) can be pre-packaged and distributed off the shelf by retailers. The pre-packaged container (1) can contain any of various retail products such as small tools, fasteners, materials, or otherwise, which allows the user to purchase the container (1) including the clip (2) which can be releasably clipped to another to a substrate material (7), or purchase the container (1) including the clip (2) having a clip aperture edge (32) configured as the first of the pair of mateable fasteners (9) which can be releasably fastened to a second of the pair of mateable fasteners (10).

As can be easily understood from the foregoing, the basic concepts of the present invention may be embodied in a variety of ways. The invention involves numerous and varied embodiments of a container (1) and methods for making and using such container (1) including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “clip” should be understood to encompass disclosure of the act of “clipping”—whether explicitly discussed or not—and, conversely, were there is a disclosure of the act of “clipping”, such a disclosure should be understood to encompass disclosure of a “clip” and even a “means for clipping”. Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Further, for the purposes of the present invention, the term “coupled” or derivatives thereof can mean indirectly coupled, coupled, directly coupled, connected, directly connected, or integrated with, depending upon the embodiment.

Additionally, for the purposes of the present invention, the term “integrated” when referring to two or more components means that the components (i) can be united to provide a one-piece construct, a monolithic construct, or a unified whole, or (ii) can be formed as a one-piece construct, a monolithic construct, or a unified whole. Said another way, the components can be integrally formed, meaning connected together so as to make up a single complete piece or unit, or so as to work together as a single complete piece or unit, and so as to be incapable of being easily dismantled without destroying the integrity of the piece or unit.

Thus, the applicant(s) should be understood to claim at least: i) each of the containers herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The elements following an open transitional phrase such as “comprising” may in the alternative be claimed with a closed transitional phrase such as “consisting essentially of” or “consisting of” whether or not explicitly indicated the description portion of the specification.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A container, comprising:
a container body having container sidewalls extending from a container bottom to a container rim; and
a clip including a clip arm having a clip arm first end attached to said container body proximate said container rim and downwardly extending to terminate in a clip second end, wherein said clip configured to receive a substrate material between said clip arm and said container body to removably secure said container to said substrate material.

2. The container of claim 1, wherein said clip arm comprises a resiliently flexible material adapted to resiliently flex to assert a compression force on said substrate material disposed between said clip arm and said container body.

3. The container of claim 2, wherein said clip arm including an inward curvature proximate the clip second end configured to enhance compression force exerted on said substrate material disposed between said clip arm and said container body.

4. The container of claim 3, wherein said clip arm including an outward curvature proximate said clip second end to dispose said clip second end a distance from said container body, wherein said outward curvature configured to allow said clip second end to guide said substrate material to a position between said container body and said clip arm.

5. The container of claim 1, wherein said clip arm including a clip aperture circumscribed by clip aperture edges.

6. The container of claim 5, wherein said clip aperture edges define a first of a pair of mateable fasteners removably mateable to a second of said pair of mateable fasteners to removably affix said container to a substrate material or a device.

7. The container of claim 6, wherein said second of said pair of mateable fasteners including a post terminating a post end which outwardly radially extends from said post, wherein said post end configured to pass through said clip aperture, wherein said post end disposed between said clip arm and said container body removably mateably secures said first of said pair of mateable fasteners to said second of said pair of mateable fasteners.

8. The container of claim 7, wherein said clip aperture edges further defining a post receiving channel having a channel first end open to said clip aperture and extending toward said clip first end to terminate in a closed channel second end, wherein said post end configured to pass through said clip aperture and said post configured to slidably pass into said post receiving channel to dispose said post end between said clip arm and said container body to removably mateably secure said first of said pair of mateable fasteners to said second of said pair of mateable fasteners.

9. The container of claim 5, wherein said clip aperture edges define a first of a pair of mateable fasteners removably mateable to a second of a pair of mateable fasteners to removably affix said container to said substrate material or a device.

10. The container of claim 9, wherein said first of said pair of mateable fasteners includes said clip aperture edges define a clip aperture including a post receiving channel having a channel first end open to said clip aperture and extending toward said clip first end to terminate in a closed channel second end, wherein said second of said pair of mateable fasteners including post terminating a post end which outwardly radially extends from said post, wherein said post end configured to pass through said clip aperture and slidably pass into said post receiving channel to dispose said post end between said clip arm and said container body to removably mateably secure said first of said pair of mateable fasteners to said second of said pair of mateable fasteners.

11. The container of claim 10, wherein said post and said post receiving channel configured to arrest rotation of said post slidably engaged with said post receiving channel.

12. The container of claim 11, wherein said post includes a pair of substantially parallel opposed post sides and said post receiving channel correspondingly includes a pair of substantially parallel opposed channel edges, whereby said post slidably inserted into the post receiving channel arrested from rotation within the post receiving channel.

13. The container of claim 11, wherein said post receiving channel includes opposed channel edges which inwardly taper approaching said channel second end, wherein opposed post sides correspondingly taper between a post taper narrow end and a post taper wide end, whereby said post slidingly received in said post receiving channel generates an interference fit between the tapered opposed post sides and the tapered post receiving channel edges.

14. The container of and one of claims 10 through 13, wherein proximate said channel first end one or both of said opposed channel edges include a detent over which the post can be forcibly urged and resists release of said post received into the post receiving channel.

15. The container of claim 6, wherein said second of said pair of mateable fasteners coupled to a hanger configured to attach to a substrate material.

16. The container of claim 15, wherein said hanger configured to attach to a perforated substrate material.

17. The container of claim 16, wherein said hanger includes hanger prong configured to pass thorough a hole in said perforated material to secure said hanger to said perforated substrate material.

18. The container of claim 17, wherein said hanger including a bifurcate hanger prong extending from said second of said pair of mateable fasteners, wherein each of said hanger prongs terminating in a prong hook.

19. The container of claim 18, wherein each of said prong hooks including a first bend substantially perpendicular to longitudinal axis of each corresponding hanger prong to afford an outward extent of said hanger prong of greater thickness than said perforated substrate material and a second bend substantially perpendicular to said outward extent of said hanger prong to afford a longitudinal extent of the hanger prong (56) which terminates in a prong free end, wherein said prong free ends correspondingly insert through a hole in said perforated material from a perforated material front surface to a perforated material back surface to dispose said outward extent of said hanger prong on a perforated material hole periphery with said longitudinal extent contacting said perforated material back surface.

20. The container of claim 6, wherein said second of said pair of mateable fasteners coupled to a belt mountable device.

21. The container of claim 6, wherein said second of said pair of mateable fasteners coupled to a receptacle.
